(19) United States
(12) Patent Application Publication
(10) Pub. No.: US 2021/0149355 A1
(43) Pub. Date: May 20, 2021

(54) INFORMATION PROCESSING APPARATUS, SYSTEM, METHOD AND PROGRAM

(71) Applicant: Ubiden, Inc., Tokyo (JP)

(72) Inventors: Norio Yamaguchi, Tokyo (JP); Tatsuro Shiraishi, Tokyo (JP); Shuhei Onishi, Tokyo (JP)

(73) Assignee: Ubiden, Inc., Tokyo (JP)

(21) Appl. No.: 17/109,379

(22) Filed: Dec. 2, 2020

(30) Foreign Application Priority Data
Oct. 2, 2019 (JP) 2019181854

(51) Int. Cl. G05B 19/042; H04W 12/06; G06K 7/14

(52) U.S. Cl. CPC G05B 19/042; H04W 12/06; G05B 2219/2637; G05B 2219/2639; G06K 7/1417

(57) ABSTRACT

An information processing apparatus capable of realizing energy usage management accompanied by authentication, with respect to an energy supplied from an energy output section and used in a supply target, without providing an additional apparatus in an energy output section is provided. The information processing apparatus receives, from a user terminal apparatus, a read data of a code image attached to the energy output section, identification information of a user or a terminal apparatus, and identification information of a supply target, performs authentication based on the identification information of the user or the terminal apparatus and the identification information of the supply target, receives, from the supply target, the identification information of the supply target and usage information of energy, specifies identification information of the energy output section based on the read data of the code image, and stores the identification information of the energy output section, the identification information of the user or the terminal apparatus, the identification information of the supply target, and the usage information of energy, in association with each other.

### TECHNICAL FIELD

CROSS REFERENCE TO RELATED APPLICATIONS: The present application claims priority to Japanese Patent Application (Application Number: Japanese Patent Application No. 2019-181854) entitled “INFORMATION PROCESSING APPARATUS, SYSTEM, METHOD AND PROGRAM” filed on Oct. 2, 2019, which is incorporated herein by reference.

The present invention relates to information processing apparatuses, systems, methods and programs that manage a use of an energy such as an electric power.

### BACKGROUND ART

A system of managing a power usage via a power input/output section such as an electrical outlet or a plug is conventionally known. For example, Patent Literature 1 discloses a system provided with a power-supply gate apparatus that receives a power from a power line and controls a power supply based on a key code, a server apparatus that transmits a key code corresponding to identification information for identifying the power-supply gate apparatus, and a mobile outlet. The mobile outlet is removable from the power-supply gate apparatus, receives the identification information from the power-supply gate apparatus, receives the key code corresponding to the identification information from the server apparatus, and provides the key code to the power-supply gate apparatus. According to the system in Patent Literature 1, it is described that an electric power can be easily used by attaching the mobile outlet to the power-supply gate apparatus even in such as the go.

### CITATION LIST

### Patent Literature

Patent Literature 1: Japanese Unexamined Patent Application Publication No. 2002-325357.

### SUMMARY OF INVENTION

### Technical Problem

However, in the foregoing conventional system, there is a problem that the power-supply gate apparatus for controlling the power supply from the power line needs to be provided as an additional apparatus, and it is required of the mobile outlet having a dedicated authentication function that transmits and receives authentication information (identification information, key code) between the power-supply gate apparatus and the server.

### Solution to Problem

An information processing apparatus according to an aspect of the present invention is an information processing apparatus that manages a use of an energy. This information processing apparatus comprises a terminal communication section that receives, from a terminal apparatus of a user, a read data of a code image attached to an energy output section, identification information of the user or the terminal apparatus and identification information of a supply target to which an energy is supplied from the energy output section, an authentication processing section that performs authentication based on the identification information of the user or the terminal apparatus and the identification information of the supply target, a supply-target communication section that receives, from the supply target, the identification information of the supply target and usage information of energy supplied from the energy output section and used in the supply target, and a storage section that specifies identification information of the energy output section based on the read data of the code image and stores the identification information of the energy output section, the identification information of the user or the terminal apparatus, the identification information of the supply target and the usage information of energy, in association with each other.

An information processing apparatus according to another aspect of the present invention is an information processing apparatus that manages a use of an energy. The information processing apparatus comprises a terminal communication section that receives, from a terminal apparatus of a user, a read data of an identification-auxiliary image attached to an energy output section, position information of the terminal apparatus, identification information of the user or the terminal apparatus and identification information of a supply target to which an energy is supplied from the energy output section, an authentication processing section that performs authentication based on the identification information of the user or the terminal apparatus and the identification information of the supply target, a supply-target communication section that receives, from the supply target, the identification information of the supply target and usage information of energy supplied from the energy output section and used in the supply target, and a storage section that specifies identification information of the energy output section based on the read data of the identification auxiliary image and the position information and stores the identification information of the energy output section, the identification information of the user or the terminal apparatus, the identification information of the supply target and the usage information of energy, in association with each other.

A method according to still another aspect of the present invention is a method of controlling a use of an energy. The method includes receiving, from a terminal apparatus of a user, a read data of a code image attached to an energy output section, identification information of the user or the terminal apparatus and identification information of a supply target to which an energy is supplied from the energy output section, performing authentication based on the identification information of the user or the terminal apparatus and the identification information of the supply target, receiving, from the supply target, the identification information of the supply target and usage information of energy supplied from the energy output section and used in the supply target, and specifying identification information of the energy output section based on the read data of the code image and storing the identification information of the energy output section, the identification information of the user or the terminal apparatus, the identification information of the supply target and the usage information of energy, in association with each other.

A method according to still another aspect of the present invention is a method of controlling a use of an energy. The method includes receiving, from a terminal apparatus of a user, a read data of an identification auxiliary image attached to an energy output section, position information of the terminal apparatus, identification information of the user or the terminal apparatus and identification information of a supply target to which an energy is supplied from the energy output section, performing authentication based on the identification information of the user or the terminal apparatus and the identification information of the supply target, receiving, from the supply target, the identification information of the supply target and usage information of energy supplied from the energy output section and used in the supply target, and specifying identification information of the energy output section based on the read data of the identification auxiliary image and the position information and storing the identification information of the energy output section, the identification information of the user or the terminal apparatus, the identification information of the supply target and the usage information of energy, in association with each other.

A program according to still another aspect of the present invention is a program executed in a computer or processor provided in an information processing apparatus that manages a use of an energy. The program includes a program code for receiving, from a terminal apparatus of a user, a read data of a code image attached to an energy output section, identification information of the user or the terminal apparatus and identification information of a supply target to which an energy is supplied from the energy output section, a program code for performing authentication based on the identification information of the user or the terminal apparatus and the identification information of the supply target, a program code for receiving, from the supply target, the identification information of the supply target and usage information of energy supplied from the energy output section and used in the supply target, and a program code for specifying identification information of the energy output section based on the read data of the code image and storing the identification information of the energy output section, the identification information of the user or the terminal apparatus, the identification information of the supply target and the usage information of energy, in association with each other.

A program according to still another aspect of the present invention is a program executed in a computer or processor provided in an information processing apparatus that manages a use of an energy. The program includes a program code for receiving, from a terminal apparatus of a user, a read data of an identification auxiliary image attached to an energy output section, position information of the terminal apparatus, identification information of the user or the terminal apparatus and identification information of a supply target to which an energy is supplied from the energy output section, a program code for performing authentication based on the identification information of the user or the terminal apparatus and the identification information of the supply target, a program code for receiving, from the supply target, the identification information of the supply target and usage information of energy supplied from the energy output section and used in the supply target, and a program code for specifying identification information of the energy output section based on the read data of the identification auxiliary image and the position information and storing the identification information of the energy output section, the identification information of the user or the terminal apparatus, the identification information of the supply target and the usage information of energy, in association with each other.

A system that manages a use of an energy according to still another aspect of the present invention comprises any one of the foregoing information processing apparatuses, and at least one of the foregoing terminal apparatus and the foregoing supply target.

In the foregoing information processing apparatus, the method and the program, the identification auxiliary image may be a character, a pattern, an illustration or a mark drawn on a removable seal member attached to the energy output section.

In the foregoing information processing apparatus, the method and the program, with respect to a usage fee of an energy usage by the supply target via the energy output section, a process of fee-charging for at least one of the user, the supply target and the terminal apparatus may be performed.

In the foregoing information processing apparatus, the method and the program, the energy used in the supply target may be an electric power, the energy output section may be an electrical outlet, and the usage information of energy may include an amount of electric power used in the supply target.

In the foregoing information processing apparatus, the method and the program, the supply target may be a vehicle, and the identification information of the supply target and the usage information of energy may be received from an external communication section provided in an in-vehicle apparatus of the vehicle.

### Advantageous Effects of Invention

According to the present invention, it is capable of realizing an energy usage management accompanied by authentication, with respect to an energy supplied from an energy output section and used in a supply target, without providing an additional apparatus in the energy output section.

### BRIEF DESCRIPTION OF DRAWINGS

FIG. 1 is an illustration showing an example of a schematic configuration of a power-usage management system according to an embodiment.

FIG. 2 Each of FIGS. 2 (a) to 2(c) is an illustration showing an example of an image attached to an electrical outlet according to the embodiment.

FIG. 3 is a block diagram showing an example of a configuration of main functions of a server according to the embodiment.

FIG. 4 is a flowchart showing an example of a power-usage management process in a server according to the embodiment.

### DESCRIPTION OF EMBODIMENTS

Hereinafter, embodiments of the present invention are described with reference to the drawings.

A system according to an embodiment of the present invention is a system that manages a use of an energy supplied from an energy output section and used in a supply target. The energy to be used may be, for example, a primary energy in the form of oil, natural gas, coal, or the like, or a secondary energy in the form of electricity, hydrogen, gasoline, light oil, heavy oil, city gas, alcohol, or the like. A supply target to which an energy is supplied is, for example, an electric moving body driven by a battery-mounted motor. The moving body may be a moving body on the ground such as an electric vehicle or a fuel cell vehicle, an aerial moving body such as a drone, or a moving body such as a ship moving on water such as the sea. The moving body may be a vehicle having four or more wheels, a three-wheeled vehicle (tricycle), a two-wheeled vehicle (motorcycle, bicycle), a truck, a bus, a private vehicle, a commercial vehicle, or the like. The battery may be owned by the user oneself, may be leased from a leasing company, or may be owned by a business operator different from the user. Further, the supply target may be an electric device or an electronic device such as a portable or stationary home appliance, an office device and a communication terminal apparatus.

In the following embodiments, as an example, a case is described in which an energy to be used is an electric energy, an energy output section that outputs the energy is an electrical outlet that outputs an electrical energy, a supply target to which an energy is supplied is a battery for driving which is installed in a vehicle, and a system is a power-usage management system that manages a power usage when electrically charging the battery of the vehicle with the electric power output from the electrical outlet.

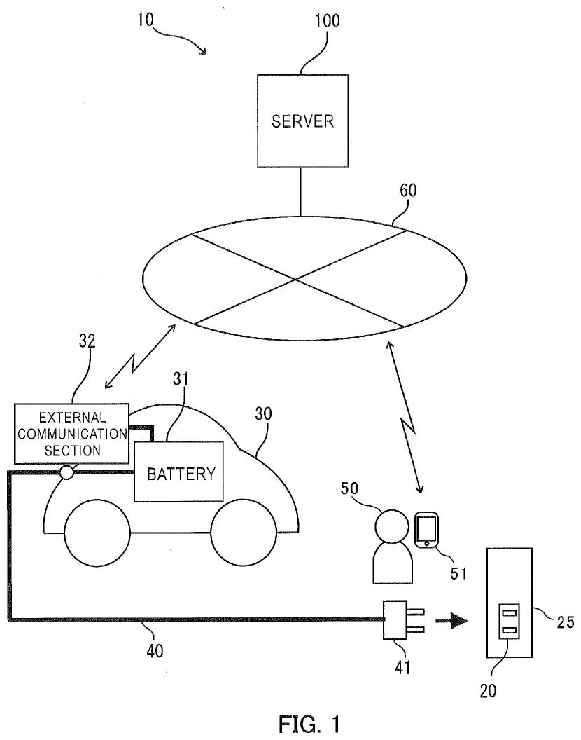

FIG. 1 is an illustration showing an example of a schematic configuration of a power-usage management system 10 according to the present embodiment. In FIG. 1, the power-usage management system 10 manages an electric power usage of a supply target to which an electric power is supplied from an electrical outlet 20. The supply target in the present embodiment is a battery 31 of a vehicle 30, which is charged by the electric power from the electrical outlet 20. The power supply from the electrical outlet 20 is performed via, for example, a wired power cable 40 and a plug 41. The power supply from the electrical outlet 20 may be performed by a wireless power supply such as an electromagnetic induction, a power supply by a radio wave such as a microwave and a power supply by a light such as a laser light. Further, the voltage (current) supplied from the electrical outlet 20 may be alternating current or direct current.

The power-usage management system 10 includes a server 100 as an information processing apparatus that manages an electric power (electrical energy) usage. The server 100 may be configured by a single computer apparatus, may be configured to link a plurality of computer apparatuses, or may be configured by a cloud system on a network.

The electrical outlet 20 as an energy output section capable of outputting an electric power (electrical energy) is, for example, an electrical outlet provided on an inner or outer wall 25 of a building, a stand of an outdoor or indoor charging facility (charging station), or the like. The electrical outlet 20 may be a general-purpose outlet with no limitation of use, or may be a dedicated outlet with a limitation of use. Further, the electrical outlet 20 may be an electrical outlet for which a user is not limited, or an electrical outlet that can be used only by a specific user.

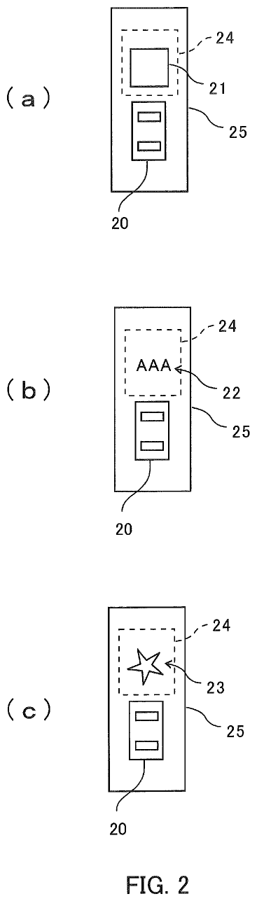

Each of FIGS. 2(a) to 2(c) is an illustration showing an example of an image attached to the electrical outlet 20 according to the embodiment. A code image (for example, an image of a QR code (registered trademark)) 21 is attached to the electrical outlet 20 in FIG. 2(a). The code image 21 may be a one-dimensional code image or a two-dimensional code image. The code image 21 is, for example, an image in which information such as the name, identification number, installation location, and entity of outlet installation for the electrical outlet 20 is encoded.

The electrical outlet 20 in FIG. 2(b) is provided with an image of characters (for example, handwritten characters) 22 as an identification auxiliary image of the electrical outlet 20 optionally attached by a user, an entity of outlet installation or the like. Further, the electrical outlet 20 in FIG. 2(c) is provided with an image of an illustration 23 as an identification auxiliary image optionally attached by a user, an entity of outlet installation or the like. The characters 22 or the illustration 23 may be attached to the electrical outlet 20. The characters 22 and the illustration 23 of the electrical outlet 20 may be drawn on a seal member 24 and attached to a side of the electrical outlet 20 by a user, an entity of outlet installation or the like. It is noted that the identification auxiliary image may be a pattern or a mark, besides the characters and the illustration.

A terminal apparatus 51 of a user 50 who intends to use the electric power supplied from the electrical outlet 20 can communicate with the server 100 via a communication network 60 such as a mobile communication network or the Internet. The terminal apparatus 51 includes an operation section such as a key, a button and a touch panel, a display section such as a liquid crystal display, and an imaging section such as a camera that takes the code image of the electrical outlet, the identification auxiliary image or the like. The terminal apparatus 51 can activate and execute a predetermined power usage application installed in advance by being operated by the user. The terminal apparatus 51 may include a current-position acquisition section such as a GNSS receiver that acquires information on the current position of its own apparatus. The terminal apparatus 51 may be, for example, a mobile station (also referred to as a “mobile device”, a “user equipment (UE)”, etc.) capable of communicating via a mobile communication network of the fourth generation or the fifth generation or the later generation.

The vehicle 30 can communicate with the server 100 via the communication network 60 by an external communication section 32 of an in-vehicle apparatus. The external communication section 32 may be, for example, a remote control unit (TCU: Telematic Control Unit) connected to an in-vehicle network (CAN: Controller Area Network) via a gateway. The remote control unit (TCU) may have a short-range radio communication function such as wireless LAN or Bluetooth (registered trademark) in addition to the communication function via the communication network 60. The in-vehicle network (CAN) is connected to a battery management system (BMS) that manages the battery 31 and one or more electronic control units (ECU) that control other parts, in addition to the remote control unit (TCU).

Usage information of power (for example, battery identification information, amount of electric power, power-charging start time, power-charging end time) regarding the electric power used for charging the battery 31 can be transmitted, for example, from the battery management system (BMS) to the server 100 via the remote control unit (TCU). Vehicle identification information can be transmitted, for example, from the electronic control unit (ECU) having a memory of storing basic information on the vehicle, to the server 100 via the remote control unit (TCU). The transmission of these pieces of information to the server 100 is executed, for example, based on a transmission request generated by the application running on the terminal apparatus 51. The transmission request from the terminal apparatus 51 may be received by the remote control unit (TCU) of the vehicle, for example, via the short-range radio communication such as a wireless LAN or Bluetooth (registered trademark).

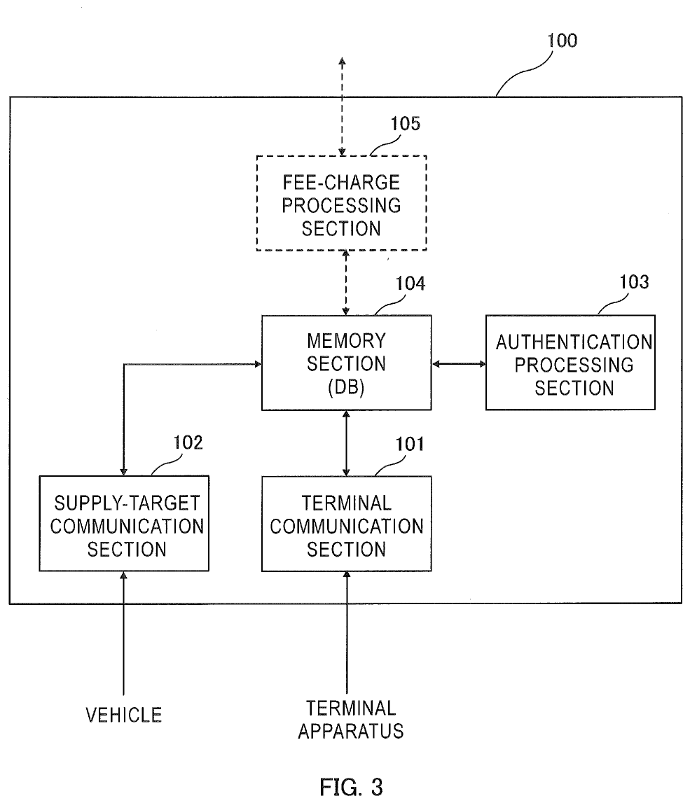

FIG. 3 is a block diagram showing an example of a configuration of main functions of the server 100 according to the embodiment. In FIG. 3, the server 100 includes a terminal communication section 101, a supply-target communication section 102, an authentication processing section 103, and a storage section (DB: database) 104.

In an example of the power usage management, the terminal communication section 101 receives a read data of the code image (for example, the image of the QR code (registered trademark)) 21 (see FIG. 2(a)) attached to the electrical outlet 20, identification information of the user 50 or the terminal apparatus 51, and identification information of a supply target to which an electric power is supplied from the electrical outlet 20 (for example, identification information of the vehicle 30 or the battery 31), from the terminal apparatus 51 of the user 50 via the communication network 60. The read data of the code image 21 may be, for example, an image data obtained by taking the code image 21 with the camera of the terminal apparatus 51, or may be a data obtained by decoding the image data.

In another example of the power usage management, the terminal communication section 101 receives a read data of the identification auxiliary image 22 or 23 (see FIG. 2(a) and FIG. 2(c)) attached to the electrical outlet 20, position information of the terminal apparatus 51, and identification information of the user 50 or the terminal apparatus 51 and identification information of a supply target to which an electric power is supplied from the electrical outlet 20 (for example, identification information of the vehicle 30 or the battery 31), from the terminal apparatus 51 of the user 50 via the communication network 60. The read data of the identification auxiliary image 22 or 23 is, for example, an image data obtained by taking the identification auxiliary image 22 or 23 with the camera of the terminal apparatus 51. The position information of the terminal apparatus 51 is, for example, the position information (latitude, longitude, altitude) of the terminal apparatus 51 positioned by the GNSS receiver of the terminal apparatus 51.

The supply-target communication section 102 receives the identification information of the supply target (for example, identification information of the vehicle 30 or the battery 31), and the usage information of power (for example, battery identification information, electric energy, power-charging start time, power-charging end time) supplied from the electrical outlet 20 and used in the vehicle 30, from the vehicle 30 of the supply target.

It is noted that the terminal communication section 101 and the supply-target communication section 102 may be configured as an integrally configured communication apparatus (for example, a mobile communication module).

The authentication processing section 103 performs at least one of authentication (user authentication) of the user who uses an electric power and authentication (supply target authentication) of the supply target (for example, the vehicle 30 or the battery 31), based on the identification information of the user 50 or the terminal apparatus 51 and the identification information of the supply target (for example, the identification information of the vehicle 30 or the battery 31).

For example, the authentication processing section 103 may perform user authentication for confirming whether the user 50 is a regular user registered in advance in a predetermined power-usage management service, by comparing the identification information (user ID) of the user 50 received from the terminal apparatus 51 with the identification information (user ID) of the user registered in advance in the server 100. In this case, the use of the power-usage management service may be permitted when the user is the regular user, and the use of the power-usage management service may be restricted (for example, the use is not permitted) when the user is not the regular user.

Further, for example, the authentication processing section 103 may perform supply target authentication for confirming whether the supply target (for example, the vehicle 30 or the battery 31) is a regular supply target registered in advance in the predetermined power-usage management service, by comparing the identification information of the supply target (for example, the identification information of the vehicle 30 or the battery 31) received from the terminal apparatus 51 with the identification information of the supply target (for example, the identification information of the vehicle 30 or the battery 31) received from the vehicle 30. In this case, the use of the power-usage management service may be permitted when the supply target is the regular supply target, and the use of the power-usage management service may be restricted (for example, the use is not permitted) when the supply target is not the regular supply target. It is noted that, in this authentication, the identification information of the supply target (for example, the identification information of the vehicle 30 or the battery 31) received from the terminal apparatus 51 or the vehicle 30 may be compared with the identification information of the supply target registered in advance in the server 100 to perform the authentication process.

In an example of the power usage management, the storage section (DB) 104 specifies the identification information of the electrical outlet 20 based on the read data of the code image, and stores the identification information (outlet ID) of the electrical outlet 20, the identification information of the user 50 or the terminal apparatus 51, the identification information of the supply target (for example, identification information of the vehicle 30 or the battery 31), and the usage information of power, in association with each other. For example, as shown in TABLE 1, for each of series of power usage transactions, one record is recorded, in which the outlet ID, the user ID, the terminal ID (for example, IMEI), the vehicle ID and the electric-power usage information are associated with each other, and a power-usage transaction table (power usage ledger) is formed as a whole.

TABLE 1

| | | | | Usage |
|---|---|---|---|---|
| Outlet | | | | Information |
| ID | User ID | Terminal ID (IMEI) | Vehicle ID | of Power |
| 00001 | 00001 | AA-BBBBBB-000001-D | 00001 | X1Y1 |
| 00011 | 00002 | AA-BBBBBB-000002-D | 00100 | X1Y2 |
| . . . | . . . | | . . . | . . . |

In another example of the power usage management, the storage section (DB) 104 specifies the identification information of the electrical outlet 20 based on the above-mentioned read data of the identification auxiliary image and the current position information of the terminal apparatus 51, and stores the identification information (outlet ID) of the electrical outlet 20, the identification information of the user 50 or the terminal apparatus 51, the identification information of the supply target (for example, identification information of the vehicle 30 or the battery 31) and the usage information of power, in association with each other.

The storage section (DB) 104 also stores various tables used for the power usage management via a plurality of electrical outlets. For example, the storage section (DB) 104 stores an outlet management table in TABLE 2, a user management table in TABLE 3 and a vehicle management table in TABLE 4.

TABLE 2

| | | | | Identifi- | | |
|---|---|---|---|---|---|---|
| | | Position | | cation- | | |
| Outlet | | Informa- | Installer | Auxiliary | Registration | |
| ID | Name | tion | ID | Image | Date | . . . |
| 00001 | AAAAA | 00, 00, 00 | 00001 | ***** | 2019 Jun. 1 | . . . |
| 00002 | BBBBB | 00, 00, 00 | 00002 | ****** | 2019 Jun. 1 | . . . |
| . . . | . . . | . . . | . . . | . . . | . . . | . . . |

TABLE 3

| | | Benefit for | Registration | |
|---|---|---|---|---|
| User ID | Terminal ID (IMEI) | Fee-Charging | Date | . . . |
| 00001 | AA-BBBBBB-000001-D | 1 | 2019 May 1 | . . . |
| 00002 | AA-BBBBBB-000002-D | 0 | 2019 May 10 | . . . |
| . . . | . . . | . . . | . . . | . . . |

TABLE 4

| Vehicle | | Registration | |
|---|---|---|---|
| ID | Battery ID | Date | . . . |
| 00001 | AAAAA | 2019 May 1 | . . . |
| 00002 | AAAAB | 2019 May 10 | . . . |
| . . . | . . . | . . . | . . . |

A new record is added to each of the outlet management table, the user management table and the vehicle management table, when the electrical outlet 20, the user 50 (terminal apparatus 51) and the vehicle 30 (battery 31) for using the power-usage management service via the electrical outlet 20 provided by the server 100 in the present embodiment are newly registered. By referring to the outlet management table in TABLE 2, it is possible to construct a public-outlet virtual space indicating positions of public outlets that the user can newly register in the power-usage management service provided by the server 100 in the present embodiment. By superimposing and displaying this public-outlet virtual space on a map of the real space, the user can easily figure out and access the positions of public outlets that can be newly registered by the user.

The storage section (DB) 104 may also store a registered outlet table shown in TABLE 5. A record is added to this registered outlet table when the user newly registers the electrical outlet 20. By connecting and referring to the registered outlet table and the above-mentioned various tables, it is possible to construct a My Outlet virtual space indicating positions of registered outlets that the user can use in the power-usage management service provided by the server 100 in the present embodiment. By superimposing and displaying this My Outlet virtual space on a map of the real space, the user can easily figure out and access positions of electrical outlets that can be registered and used by the user.

TABLE 5

| Outlet | | Registration | |
|---|---|---|---|
| ID | User ID | Date | . . . |
| 00001 | 00101 | 2019 Jul. 1 | . . . |
| 00002 | 00102 | 2019 Jul. 15 | . . . |
| . . . | . . . | | . . . |

In the present embodiment, the server 100 may be provided with a fee-charge processing section 105. The fee-charge processing section 105 performs a process of fee-charging to at least one of the user 50, the supply target (vehicle 30 or battery 31) and the terminal apparatus 51, with respect to a usage fee of power usage by the vehicle 30 via the electrical outlet 20. For example, all or a part of the usage fee of power usage by the vehicle 30 via the electrical outlet 20 may be charged to the user 50 or may be fee-charged so as to be added to the usage fee for the terminal apparatus 51. If the vehicle 30 or the battery 31 is rented from a rental company or leased from a leasing company, all or a part of the usage fee of the power usage by the vehicle 30 via the electrical outlet 20 may be charged to the rental company or the leasing company.

The fee-charging process of the power usage may be performed in consideration of various benefits (benefits for fee-charging) related to the fee-charging. For example, in case that an environmental value certificate such as a “Green Power Certificate”, “J Credit” and “Non-fossil Certificate” that certify the environmental value of renewable energy such as a wind power, solar power and biomass, or something of equivalent value (hereinafter referred to as “environmental value such as the environmental value certificate”) is considered to be added to the electric current supplied to the vehicle 30 via the electrical outlet 20, the status of adding the environmental value such as the environmental value certificate may be managed by, for example, a flag in the column of benefit for fee-charging of the user management table in TABLE 3, and the environmental value may be charged (increase or decrease) in parallel with the amount of electric power. The presence or absence of the benefit for fee-charging such as a purchase of the environmental value such as the environmental value certificate can be managed by, for example, a flag in the column of benefit for fee-charging of the user management table in TABLE 3.

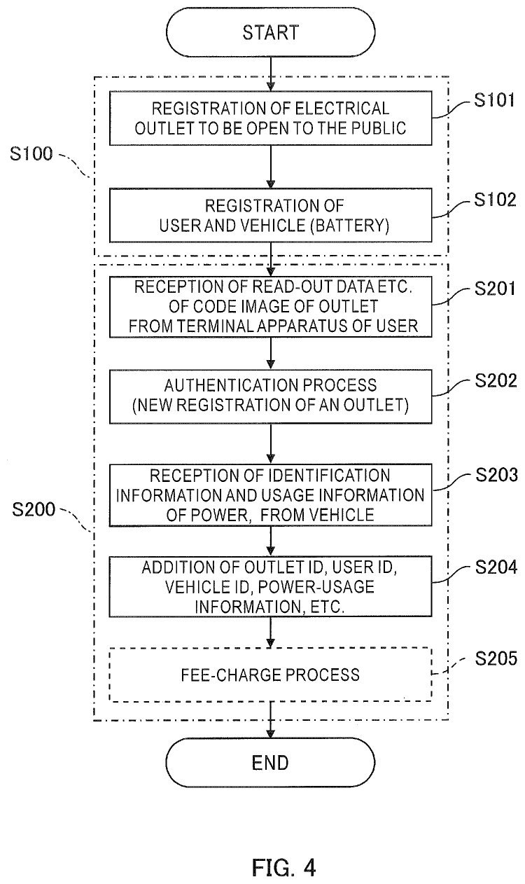

FIG. 4 is a flowchart showing an example of a power-usage management process in the server 100 according to the embodiment. In FIG. 4, the power-usage management process in the present embodiment includes a preparation phase (S100) and an operation phase (S200).

In the preparation phase (S100), with respect to a plurality of electrical outlets 20 to be open to the public by the power-usage management service, data inputs to the server 100 are performed by the operator, the server 100 creates the outlet management table in TABLE 2 described above. The server 100 also creates the user management table in TABLE 3 and the vehicle management table in TABLE 4, by receiving new registration data including the information of the users 50 and the terminal apparatuses 51 and the information of the supply targets (vehicle 30 and battery 31) from the terminal apparatuses 51 of a plurality of users 50 who use the power-usage management service.

Next, in the operation phase (S200), the user 50 operates the terminal apparatus 51 to activate an application for using the power-usage management service, takes and reads the code image 21 including the identification information of the electrical outlet 20, and selects “my car” from a menu selection displayed on the display screen of the terminal apparatus 51. By this operation, the identification information of the user 50 (or the terminal apparatus 51), the read data of the code image 21 and the identification information of the vehicle 30 (or the battery 31) pre-registered as “my car” in the terminal apparatus 51 are transmitted to the server 100. The server 100 receives the identification information of the user 50 (or the terminal apparatus 51), the read data of the code image 21 and the identification information of the vehicle 30 (or the battery 31) from the terminal apparatus 51 of the user 50 (S201).

Next, the server 100 performs an authentication process with respect to a combination of the identification information of the user 50 (or the terminal apparatus 51) and the vehicle 30 (or the battery 31), based on the identification information of the user 50 (or the terminal apparatus 51) and the identification information of the vehicle 30 (or the battery 31) which are received from the terminal apparatus 51 (S202). Herein, if the electrical outlet 20 is not registered for the user 50, the server 100 newly registers the outlet IDs of the electrical outlet 20 and the user IDs corresponding to each other, into the above-described registered outlet table in TABLE 5, as an electrical outlet that can be used by the user 50 (S202).

Next, when the power-charging of the battery 31 of the vehicle 30 by the electric power supplied from the electrical outlet 20 is completed, the vehicle 30 transmits, to the server 100, the identification information of the supply target (the identification information of the vehicle 30 or the battery 31), and the usage information of power supplied from the electrical outlet 20 and used to charge the battery 31 of the vehicle 30, upon the request of the terminal apparatus 51 of the user 50 or autonomously. The server 100 receives, from the vehicle 30, the identification information of the supply target (the identification information of the vehicle 30 or the battery 31) and the usage information of power (S203).

Next, the server 100 refers to the above-described outlet management table in TABLE 2 based on the read data of the code image, and specifies the identification information of the electrical outlet 20. Further, the server 100 stores, in the storage section (DB) 104, the identification information (outlet ID) of the electrical outlet 20, the identification information (user ID, terminal ID) of the user 50 or the terminal apparatus 51, the identification information of the supply target (vehicle ID or battery ID) and the power usage information, so as to associate them with each other and add them to the above-mentioned power-usage transaction table (power usage ledger) in Table 1 (S204).

The server 100 can manage the power usage of each user via the electrical outlet in the power-usage management service by referring to the power-usage transaction table (power usage ledger).

It is noted that the server 100 may perform a process of fee-charging to at least one of the user 50, the supply target (the vehicle 30 or the battery 31) and the terminal apparatus 51, with respect to the usage fee of the power usage by the vehicle 30 via the electrical outlet 20, by referring to the power-usage transaction table (power usage ledger) (S205).

In case of using the identification auxiliary image 22 or 23 (see FIG. 2(a) and FIG. 2(c)) attached to the electrical outlet 20, in step S201 in FIG. 4, the server 100 receives the read data of the identification auxiliary image 22 or 23 and the position information of the terminal apparatus 51 from the terminal apparatus 51, instead of the read data of the code image. Further, in step S204 in FIG. 4, the server 100 refers to the above-mentioned outlet management table in Table 2 based on the read data of the identification auxiliary image 22 or 23 and the position information of the terminal apparatus 51, and specifies the identification information of the electrical outlet 20.

As described above, according to the present embodiment, it is possible to realize the power usage management accompanied by authentication, with respect to the electric power supplied from the electrical outlet 20 and used for charging the battery 31 of the vehicle 30, without providing an additional apparatus in the electrical outlet 20.

It is noted that process steps and configuration elements such as information processing apparatuses, terminal apparatuses, and in-vehicle apparatuses of vehicles described in the present specification can be implemented with various means. For example, these process steps and configuration elements may be implemented with hardware, firmware, software, or a combination thereof.

With respect to hardware implementation, means such as processing units or the like used for establishing the foregoing steps and configuration elements in entities (for example, computer apparatus, server, terminal apparatus (user equipment, mobile station, communication terminal), in-vehicle apparatus of vehicle, hard disk drive apparatus, or optical disk drive apparatus) may be implemented in one or more of an application-specific IC (ASIC), a digital signal processor (DSP), a digital signal processing device (DSPD), a programmable logic device (PLD), a field programmable gate array (FPGA), a processor, a controller, a microcontroller, a microprocessor, a electronic device, other electronic unit, computer, or a combination thereof, which are designed so as to perform a function described in the present specification.

With respect to the firmware and/or software implementation, means such as processing units or the like for using to establish the foregoing configuration elements may be implemented with a program (for example, a code such as a procedure, a function, a module, an instruction, etc.) for performing a function described in the present specification. In general, any computer/processor readable medium of clearly materializing the code of firmware and/or software may be used for implementation of means such as processing units and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage unit, or the like. The code may be executed by one or more of computers and processors, and a certain aspect of functionalities described in the present specification may be executed by a computer or processor.

The foregoing medium may be a non-temporary recording medium. The foregoing code of the program may be readable and executable by a computer, processor, or other device or apparatus machine, and its format is not limited to a specific format. For example, the foregoing code of the program may be any of source code, object code, and binary code, or may be a mixture of two or more of these codes.

The description of embodiments disclosed in the present specification is provided so that the present disclosures can be produced or used by those skilled in the art. Various modifications of the present disclosures will be readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: power-usage management system
20: electrical outlet
21: code image
22: identification auxiliary image (character)
23: identification auxiliary image (illustration, mark, design)
24: seal material
25: wall
30: vehicle
31: battery
32: external communication section
40: power cable
41: plug
50: user
51: terminal apparatus
60: network
100: server
101: terminal communication section
102: supply-target communication section
103: authentication processing section
105: fee-charge processing section

1. An information processing apparatus for managing a use of an energy, comprising:
a terminal communication section of receiving, from a terminal apparatus of a user, a read data of a code image attached to an energy output section, identification information of the user or the terminal apparatus and identification information of a supply target to which an energy is supplied from the energy output section;
an authentication processing section of performing authentication based on the identification information of the user or the terminal apparatus and the identification information of the supply target;
a supply-target communication section of receiving, from the supply target, the identification information of the supply target and usage information of energy supplied from the energy output section and used in the supply target; and
a storage section of specifying identification information of the energy output section based on the read data of the code image, and storing the identification information of the energy output section, the identification information of the user or the terminal apparatus, the identification information of the supply target and the usage information of energy, in association with each other.

2. An information processing apparatus for managing a use of an energy, comprising:
a terminal communication section of receiving, from a terminal apparatus of a user, a read data of an identification auxiliary image attached to an energy output section, position information of the terminal apparatus, identification information of the user or the terminal apparatus and identification information of the supply target to which an energy is supplied;
an authentication processing section of performing authentication based on the identification information of the user or the terminal apparatus and the identification information of the supply target;
a supply-target communication section of receiving, from the supply target, the identification information of the supply target and usage information of energy supplied from the energy output section and used in the supply target; and
a storage section of specifying identification information of the energy output section based on the read data of the identification auxiliary image and the position information, and storing the identification information of the energy output section, the identification information of the user or the terminal apparatus, the identification information of the supply target and the usage information of energy, in association with each other.

3. The information processing apparatus according to claim 2, wherein the identification auxiliary image is a character, a pattern, an illustration or a mark drawn on a removable seal member attached to the energy output section.

4. The information processing apparatus according to claim 1, wherein the information processing apparatus comprises a fee-charge processing section of performing a process of fee-charging for at least one of the user, the supply target, a battery mounted on the supply target, and the terminal apparatus, with respect to a usage fee of an energy usage by the supply target via the energy output unit.

5. The information processing apparatus according to claim 1, wherein the energy used in the supply target is an electric power, the energy output section is an electrical outlet, and the usage information of energy includes an amount of electric power used in the supply target.

6. The information processing apparatus according to claim 1, wherein the supply target is a vehicle, and the identification information of the supply target and the usage information of energy are received from an external communication section provided in an in-vehicle apparatus of the vehicle.

7. A system for managing a use of an energy, comprising:
the information processing apparatus according to claim 1; and
at least one of the terminal apparatus and the supply target.

8. A method for managing a use of an energy, including:
receiving, from a terminal apparatus of a user, a read data of a code image attached to an energy output section, identification information of the user or the terminal apparatus and identification information of a supply target to which an energy is supplied from the energy output section;
performing authentication based on the identification information of the user or the terminal apparatus and the identification information of the supply target;
receiving, from the supply target, the identification information of the supply target and usage information of energy supplied from the energy output section and used in the supply target; and
specifying identification information of the energy output section based on the read data of the code image, and storing the identification information of the energy output section, the identification information of the user or the terminal apparatus, the identification information of the supply target and the usage information of energy, in association with each other.

9. A method for managing a use of an energy, including:
receiving, from a terminal apparatus of a user, a read data of an identification auxiliary image attached to an energy output section, position information of the terminal apparatus, identification information of the user or the terminal apparatus and identification information of a supply target to which an energy is supplied from the energy output section;
performing authentication based on the identification information of the user or the terminal apparatus and the identification information of the supply target;
receiving, from the supply target, the identification information of the supply target and usage information of energy supplied from the energy output section and used in the supply target; and
specifying identification information of the energy output section based on the read data of the identification auxiliary image and the position information, and storing the identification information of the energy output section, the identification information of the user or the terminal apparatus, the identification information of the supply target and the usage information of energy, in association with each other.

10. A program executed in a computer or processor provided in an information processing apparatus that manages a use of an energy, including:
a program code for receiving, from a terminal apparatus of a user, a read data of a code image attached to an energy output section, identification information of the user or the terminal apparatus and identification information of a supply target to which an energy is supplied from the energy output section;
a program code for performing authentication based on the identification information of the user or the terminal apparatus and the identification information of the supply target;
a program code for receiving, from the supply target, the identification information of the supply target and usage information of energy supplied from the energy output section and used in the supply target; and
a program code for specifying identification information of the energy output section based on the read data of the code image, and storing the identification information of the energy output section, the identification information of the user or the terminal apparatus, the identification information of the supply target and the usage information of energy, in association with each other.

11. A program executed in a computer or processor provided in an information processing apparatus that manages a use of an energy, including:
a program code for receiving, from a terminal apparatus of a user, a read data of an identification auxiliary image attached to an energy output section, position information of the terminal apparatus, identification information of the user or the terminal apparatus, and identification information of a supply target to which an energy is supplied from the energy output section;
a program code for performing authentication based on the identification information of the user or the terminal apparatus and the identification information of the supply target;
a program code for receiving, from the supply target, the identification information of the supply target and usage information of energy supplied from the energy output section and used in the supply target; and
a program code for specifying identification information of the energy output section based on the read data of the identification auxiliary image and the position information, and storing the identification information of the energy output section, the identification information of the user or the terminal apparatus, the identification information of the supply target and the usage information of energy, in association with each other.
